(19) United States
(12) Patent Application Publication
(10) Pub. No.: US 2018/0290443 A1
(43) Pub. Date: Oct. 11, 2018

(54) LAMINATION TECHNIQUE FOR PRODUCING ELECTRONIC DEVICES

(71) Applicant: FLEXENABLE LIMITED, Cambridge (GB)

(72) Inventors: Barry WILD, Peterborough (GB); William Henry REEVES, Cambridge (GB)

(73) Assignee: FLEXENABLE LIMITED, Cambridge (GB)

(21) Appl. No.: 15/766,619

(22) PCT Filed: Oct. 6, 2016
(86) PCT No.: PCT/EP2016/073923

§ 371 Date: Apr. 6, 2018

(30) Foreign Application Priority Data
Oct. 9, 2015 (GB) 1517922.9

(51) Int. Cl. B32B 37/12; B32B 27/06; B32B 3/04; B32B 37/22; B32B 7/04; B32B 7/14; G02F 1/1339

(52) U.S. Cl. CPC B32B 37/1292; B32B 27/06; B32B 3/04; B32B 37/22; B32B 2457/202; B32B 7/14; G02F 1/1339; B32B 2305/55; B32B 2307/42; B32B 7/045

(57) ABSTRACT

A technique for forming a plurality of liquid cells for a plurality of electronic devices, comprising: providing first and second components for laminating together to contain a liquid material; wherein at least one of the first and second components comprises spacing structures for maintaining a separation distance between the first and second components in at least two active area regions for two electronic devices; providing liquid material on at least one of the first and second components, wherein a sufficient amount of said liquid material for the whole of each active area region is provided in a respective starting area upstream of the respective active area region in the lamination direction; and successively laminating increasingly distal portions of the second component to the first component in a lamination direction, according to a technique by which said liquid material is spread out from said starting areas at least over said at least two active area regions; wherein said at least two active area regions are arranged in series in said lamination direction, and wherein the method comprises providing said spacing structures additionally in at least an intermediate region between said at least two active area regions in the lamination direction.

Some electronic devices include in an active area a functional liquid material contained between two components maintained at a separation distance in the active area by means of spacer structures in the active area. The production technique typically comprises laminating one of the two components to the other.

The inventors for the present application have worked on forming a plurality of liquid cells for a plurality of electronic devices in a single lamination process, and have identified technical problems and developed solutions to those technical problems. As discussed below, one problem identified by the inventors was contamination of the liquid cells by adhesive material and/or excessive amounts of the liquid functional material in some parts of the liquid cells, and the inventors have developed a technique to better prevent such problem.

There is hereby provided a method of forming a plurality of liquid cells for a plurality of electronic devices, the method comprising: providing first and second components for laminating together to contain a liquid material; wherein at least one of the first and second components comprises spacing structures for maintaining a separation distance between the first and second components in at least two active area regions for two electronic devices; providing liquid material on at least one of the first and second components, wherein a sufficient amount of said liquid material for the whole of each active area region is provided in a respective starting area upstream of the respective active area region in the lamination direction; and successively laminating increasingly distal portions of the second component to the first component in a lamination direction, according to a technique by which said liquid material is spread out from said starting areas at least over said at least two active area regions; wherein said at least two active area regions are arranged in series in said lamination direction, and wherein the method comprises providing said spacing structures additionally in at least an intermediate region between said at least two active area regions in the lamination direction.

There is also hereby provided a method of forming a plurality of liquid cells for a plurality of electronic devices, the method comprising: providing first and second components for laminating together to contain a liquid material; wherein at least one of the first and second components comprises spacing structures for maintaining a separation distance between the first and second components in at least two active area regions for two electronic devices; providing liquid material on at least one of the first and second components; and successively laminating increasingly distal portions of the second component to the first component in a lamination direction, according to a technique by which said liquid material is spread at least over said two active area regions; wherein said two active area regions are arranged in series in said lamination direction, and wherein the method comprises providing said spacing structures additionally in at least an intermediate region between said two active area regions in the lamination direction; wherein the spacing structures in the active area region have a different pattern to the spacing structures in said intermediate region.

There is also hereby provided a method of forming a plurality of liquid cells for a plurality of electronic devices, the method comprising: providing first and second components for laminating together to contain a liquid material; wherein at least one of the first and second components comprises spacing structures for maintaining a separation distance between the first and second components in at least two active area regions for two electronic devices; providing liquid material on at least one of the first and second components; and successively laminating increasingly distal portions of the second component to the first component in a lamination direction, according to a technique by which said liquid material is spread at least over said two active area regions; wherein said two active area regions are arranged in series in said lamination direction, and wherein the method comprises providing said spacing structures additionally in at least an intermediate region between said two active area regions in the lamination direction.

According to one embodiment, more than a sufficient amount of said liquid material for the whole of each active area region is provided in a respective starting area upstream of the respective active area region in the lamination direction.

According to one embodiment, the spacing structures in the active area region have a different pattern to the spacing structures in said intermediate region.

According to one embodiment, the method further comprises: additionally providing said spacing structures in at least a portion of said intermediate region directly adjacent to a proximal one of said two active area regions in the lamination direction.

According to one embodiment, the method further comprises additionally providing said spacing structures substantially evenly over at least a proximal half of said intermediate region in the lamination direction.

According to one embodiment, the method further comprises additionally providing said spacing structures evenly over at least a distal half of said intermediate region in the lamination direction. According to one embodiment, the method further comprises providing adhesive on at least one of said first and second components such that said adhesive is located over part but not all of said intermediate region, and wherein said spacing structures are additionally provided in a part of said intermediate region in which said adhesive is not located.

According to one embodiment, the liquid material is a material having one or more properties controllable by electrical circuitry of the device, or a material in which chemical and/or physical changes are detectable by electrical circuitry of the device.

According to one embodiment, the active area regions are the display regions of liquid crystal display devices, and the liquid material is a liquid crystal material.

According to one embodiment, the active area regions are sensing regions for sensing devices, and the liquid material is an electrochemically reactive liquid material.

According to one embodiment, the upper component is configured such that, after lamination, at least part of the base component remains uncovered by the upper component.

According to one embodiment, the upper component has a width less than that of the base component, in at least some sections of the upper component.

According to one embodiment, the upper component has a width less than that of the base component, across the whole length of the upper component.

There is also hereby provided a method of forming a plurality of liquid cells for a plurality of electronic devices, the method comprising: providing first and second components for laminating together to contain a liquid material; wherein at least one of the first and second components comprises spacing structures for maintaining a separation distance between the first and second components in at least two active area regions for two electronic devices; and wherein at least a section of the upper component has a width less than the section of the base component to which is it is laminated, so as to leave said section of the base component partially uncovered by the upper component after lamination.

Embodiments of the invention are described in detail hereunder, by way of example only, with reference to the accompanying drawings, in which:

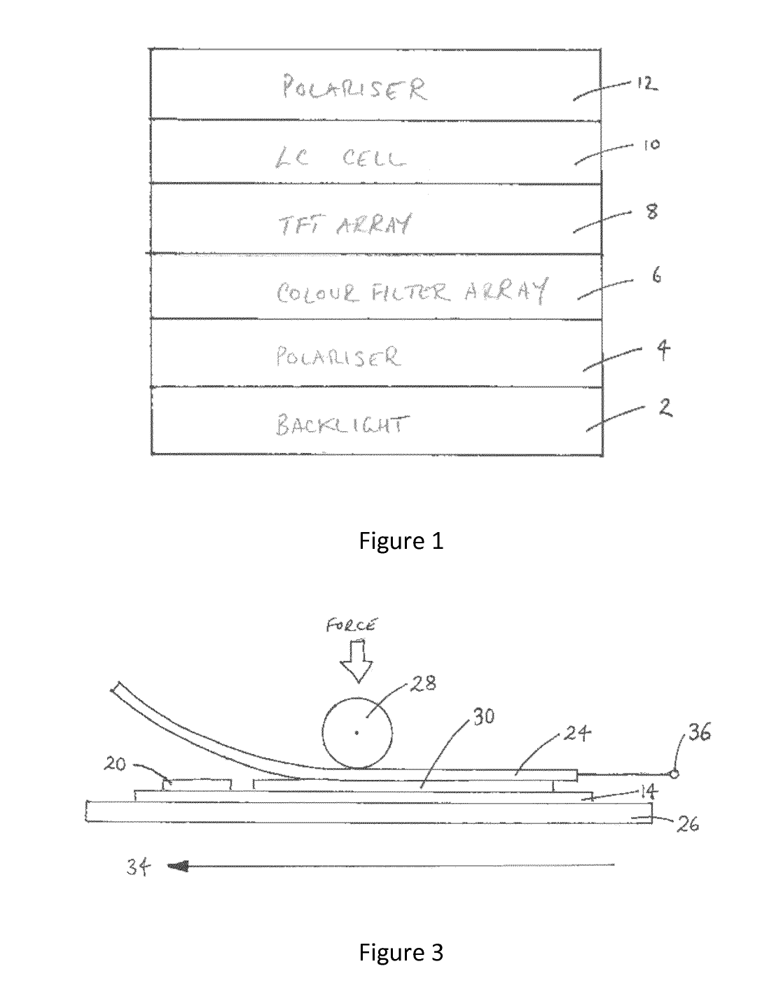

FIG. 1 illustrates one example of a liquid crystal display device;

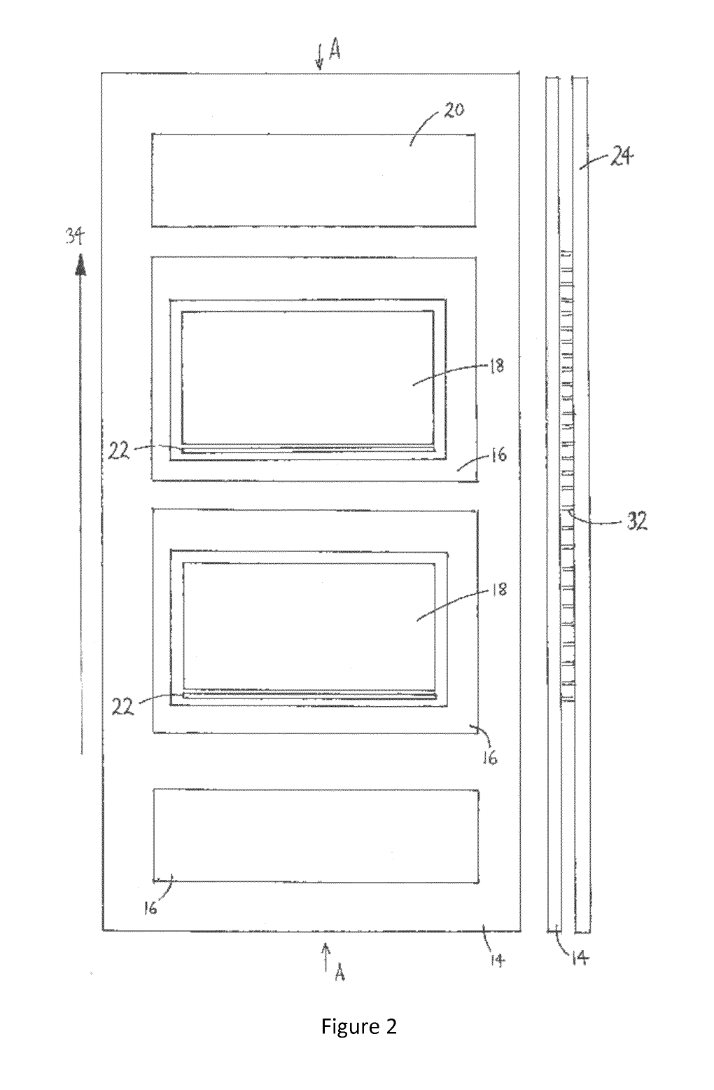

FIG. 2 illustrates one example of where to dispense adhesive and liquid crystal material on a base component prior to lamination, and one example of where to provide spacer structures on the base component;

FIG. 3 illustrates one example of a process of laminating a flexible upper component to a base component; and

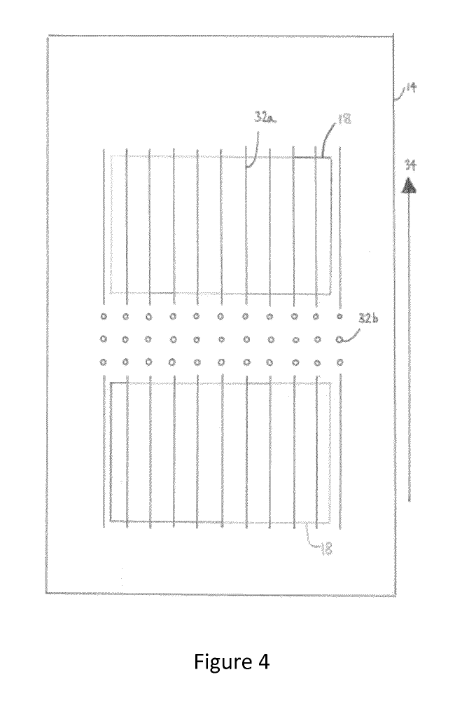

FIG. 4 illustrates one example of a spacer structure pattern.

A detailed description of a technique according to an embodiment of the invention is provided below for the example of producing a liquid crystal display (LCD) device, but the same technique is also useful in the production of other types of electronic devices including liquid cells, as discussed below.

FIG. 1 illustrates one example of a transmissive-type LCD device, but the techniques described below are also equally applicable to reflective-type LCD devices.

A transmissive-type LCD device comprises a liquid crystal cell 10 between two polarisers 4, 12.

The transmissive-type LCD device also comprises electrical circuitry 8 to independently control the electric potential at each of an array of pixel conductors and thereby independently control an electric field in the liquid crystal material of the liquid crystal cell 10 for each pixel, and thereby independently control one or more optical properties of the liquid crystal material for each pixel. The electrical circuitry may comprise an array of thin film transistors (TFTs), including one or more TFTs for each pixel, and addressing conductors for independently addressing the source and gate electrodes of one or more of the TFT(s) for each pixel from one or more driver chips outside one or more edges of the active display area. For the example of an in-plane switching (IPS) device, the electrical circuitry also comprises a common conductor on the same side of the liquid crystal material as the pixel conductors. The technique described below is also applicable to other kinds of liquid crystal devices in which the common conductor is provided on the opposite side of the liquid material to the pixel conductors.

The transmissive-type LCD device also comprises a white backlight 2 and a colour filter array 6 to enable a full colour display device. A transmissive-type LCD device may comprise additional components, and/or the order of the components may different to that shown in FIG. 1.

FIGS. 2 and 3 illustrate one example of a technique for producing in a single lamination process at least the liquid crystal cell of a plurality of LCD devices. FIG. 2 shows the liquid crystal cells for only two LCD devices for simplicity, but the same technique can be used to produce the liquid crystal cells for more than two LCD devices in a single lamination process.

The lamination technique involves laminating a flexible component 24 to a base component 14, onto which adhesive 16, 20 and liquid crystal material 22 has been pre-dispensed in the areas shown in FIG. 2.

The liquid crystal material 22 for each liquid crystal cell is dispensed in the form a line 22 parallel to, but slightly spaced apart from the upstream edge of the active display area 18.

The adhesive 16 is provided to prevent delamination during cell assembly and to contain the liquid crystal material. The adhesive may be deposited in the areas 16, 20 in the form of continuous lines of adhesive.

As shown in the right-half of FIG. 2 (which shows how spacer structures are distributed in the lamination direction (e.g. along line A-A)), spacer structures 32 are provided on at least one of the base and upper components 14, 24 not only in the active display areas 18 but are also distributed across the whole of the intermediate area between the two active display areas 18 for the two LCD devices in the lamination direction 34. The spacer structures 32 may, for example, form an integral part of the base component 14. For example, they may be formed by photolithographically patterning an insulator layer of the base component 14. The spacer structures may, for example, comprise columns (having substantially the same dimensions in the plane of the base component), and/or may comprise rib structures having relatively long dimensions in the lamination direction and relatively short dimensions in a perpendicular direction.

The base component 14 may itself be a flexible component and supported on a relatively rigid carrier 26 during the lamination process. The base component 14 may, for example, include a plastic support film supporting a colour filter array and a stack of patterned conductor, semiconductor and insulator layers to define an array of TFTs, pixel conductors and addressing conductors for addressing the TFTs from one or more driver chips outside the active display area 18. The upper component 24 may be dimensioned or shaped such that it can be laminated to the side of the base component 14 including the addressing circuitry without covering the terminals of the addressing circuitry outside the active display area, which terminals are, for example, for connection to the terminals of one or more driver chips to be bonded directly to the base component 14. For example, the upper component 24 may have a width (dimension perpendicular to the lamination direction) less than that of the base component 14, across the whole length of the upper component.

The flexible upper component 24 may also comprise a polariser 12 and/or other components of the LCD device, such as a common conductor (COM) for some types of LCD devices.

The base and upper components 14, 24 also comprise alignment coatings adjacent to the liquid crystal material in the finished liquid crystal cell, which alignment coatings influence the orientation of the molecules of the liquid crystal material.

The lamination process involves using a roller 28 to successively force increasingly distal portions of the flexible upper component against the base component, whilst a proximal end of the flexible upper component 24 is secured to a fixed point 36 to hold the portion of the flexible upper component 24 upstream of the roller 28 (i.e. the portion of the upper component between the roller 28 and the fixed point 36) in tension. The lamination process continues until the roller 28 is located over (or beyond) the most distal portion 20 of the adhesive.

In FIG. 3, the element labelled 30 collectively indicates the spacer structures 32, adhesive 16 and liquid crystal material 22 dispensed onto the base component 14. During the lamination process, each line of liquid crystal material 22 for a LCD device becomes spread over the whole of the active display area 18 for that LCD device.

The inventors for the present application have found that including spacer structures 32 in the intermediate region between the two active display areas 18 helps to prevent adhesive contaminating the active display areas 18 and/or excessive amounts of liquid crystal material developing in parts of the liquid crystal cells. Without wishing to be bound by theory, it is thought that these additional spacer structures 32 in the intermediate region are effective because they reduce the risk of any excess liquid crystal material from one active display area spreading into, and carrying adhesive material 16 into, the next active display area 18 (in the direction of lamination), by providing a well of relatively large volume for excess liquid crystal material in between two active display areas.

In one embodiment, the spacer structures 32 are evenly distributed over at least a proximal half of the intermediate region between the two active display areas in the lamination direction. In another embodiment, the spacer structures 32 are evenly distributed over at least a distal half of the intermediate region between the two active display areas in the lamination direction. In one embodiment, the spacer structures are also located in at least a portion of the intermediate region between the two active display areas in which adhesive material is not dispensed.

In one embodiment illustrated in FIG. 4, the spacer structures 32a in the active area regions 18 have a different pattern to the spacer structures 32b in the intermediate region. The pattern of the spacer structures 32a in the active area regions 18 is better (than the different pattern of the spacer structures 32b in the intermediate region) at maintaining a uniform thickness of the liquid material between the base and upper components; and the pattern of the spacer structures 32b in the intermediate region is better (than the pattern of the spacer structures 32a in the intermediate region) at providing a well of relatively large volume for excess liquid material in between two active display areas.

As mentioned above, the techniques described above are also useful for the production of electronic devices other than liquid crystal display devices. For example, the techniques described above are also useful for the production of other types of electronic devices that contain a liquid functional material between two components, such as an electronic gas sensor device comprising between two components an electrochemically reactive liquid material that chemically reacts with a gas to be sensed when such gas comes into contact with the liquid material via through holes in one or more of the base and upper components, which chemical reaction can be detected by electrical circuitry of the device. In such a sensing device, the spacer structures may be defined in the conductor layer that also defines one or more conductors via which an electrochemical reaction of the liquid can be detected.

In addition to any modifications explicitly mentioned above, it will be evident to a person skilled in the art that various other modifications of the described embodiments may be made within the scope of the invention.

1. A method of forming a plurality of liquid cells for a plurality of electronic devices, the method comprising: providing first and second components for laminating together to contain a liquid material; wherein at least one of the first and second components comprises spacing structures for maintaining a separation distance between the first and second components in at least two active area regions for two electronic devices; providing liquid material on at least one of the first and second components, wherein a sufficient amount of said liquid material for the whole of each active area region is provided in a respective starting area upstream of the respective active area region in the lamination direction; and successively laminating increasingly distal portions of the second component to the first component in a lamination direction, according to a technique by which said liquid material is spread out from said starting areas at least over said at least two active area regions; wherein said at least two active area regions are arranged in series in said lamination direction, and wherein the method comprises providing said spacing structures additionally in at least an intermediate region between said at least two active area regions in the lamination direction.

2. The method according to claim 1, wherein more than a sufficient amount of said liquid material for the whole of each active area region is provided in a respective starting area upstream of the respective active area region in the lamination direction.

3. The method according to claim 1, wherein the spacing structures in the active area region have a different pattern to the spacing structures in said intermediate region.

4. A method of forming a plurality of liquid cells for a plurality of electronic devices, the method comprising: providing first and second components for laminating together to contain a liquid material; wherein at least one of the first and second components comprises spacing structures for maintaining a separation distance between the first and second components in at least two active area regions for two electronic devices; providing liquid material on at least one of the first and second components; and successively laminating increasingly distal portions of the second component to the first component in a lamination direction, according to a technique by which said liquid material is spread at least over said two active area regions; wherein said two active area regions are arranged in series in said lamination direction, and wherein the method comprises providing said spacing structures additionally in at least an intermediate region between said two active area regions in the lamination direction; wherein the spacing structures in the active area region have a different pattern to the spacing structures in said intermediate region.

5. The method according to claim 1, comprising additionally providing said spacing structures in at least a portion of said intermediate region directly adjacent to a proximal one of said two active area regions in the lamination direction.

6. The method according to claim 1, comprising additionally providing said spacing structures substantially evenly over at least a proximal half of said intermediate region in the lamination direction.

7. The method according to claim 1, comprising additionally providing said spacing structures evenly over at least a distal half of said intermediate region in the lamination direction.

8. The method according to claim 1, providing adhesive on at least one of said first and second components such that said adhesive is located over part but not all of said intermediate region, and wherein said spacing structures are additionally provided in a part of said intermediate region in which said adhesive is not located.

9. The method according to claim 1, wherein the liquid material is a material having one or more properties controllable by electrical circuitry of the device, or a material in which chemical and/or physical changes are detectable by electrical circuitry of the device.

10. The method according to claim 1, wherein the active area regions are the display regions of liquid crystal display devices, and the liquid material is a liquid crystal material.

11. The method according to claim 1, wherein the active area regions are sensing regions for sensing devices, and the liquid material is an electrochemically reactive liquid material.

12. The method according to claim 1, wherein the upper component is configured such that, after lamination, at least part of the base component remains uncovered by the upper component.

13. The method according to claim 12, wherein the upper component has a width less than that of the base component, in at least some sections of the upper component.

14. The method according to claim 13, wherein the upper component has a width less than that of the base component, across the whole length of the upper component.

15. A method of forming a plurality of liquid cells for a plurality of electronic devices, the method comprising: providing first and second components for laminating together to contain a liquid material; wherein at least one of the first and second components comprises spacing structures for maintaining a separation distance between the first and second components in at least two active area regions for two electronic devices; and wherein at least a section of the upper component has a width less than the section of the base component to which is it is laminated, so as to leave said section of the base component partially uncovered by the upper component after lamination.
